(19) United States
(12) Patent Application Publication
(10) Pub. No.: US 2006/0077218 A1
(43) Pub. Date: Apr. 13, 2006

(54) Method for controlling an image processing apparatus, image processing apparatus, and program for controlling an image processing apparatus

(75) Inventor: Masayuki Hongo, Yokohama-shi (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/242,342

(22) Filed: Oct. 3, 2005

(30) Foreign Application Priority Data
Oct. 8, 2004 (JP) 2004-295527

(51) Int. Cl. B41J 2/205

(52) U.S. Cl. 347/15

(57) ABSTRACT

An image processing apparatus is provided which is adapted to control image reading and recording operations in a balanced manner, thereby reducing power consumption includes image reading and recording portions; a power supply portion configured to supply power to the reading and recording portions in common; a detecting portion for detecting a recording density of image data to be recorded; and a controller configured to compare a detection result of the recording density with a predetermined threshold. Additionally, a control method and computer readable medium is provided for accomplishing the aforementioned in the apparatus.

### BACKGROUND OF THE INVENTION

1. Field of the Invention

The present invention relates to an image control apparatus, and method thereof, for controlling the apparatus which includes an image reader and an image recorder both operable by power supplied from a common power supply portion.

2. Description of the Related Background Art

In recent years, as the use of personal computers, digital cameras, and the like increases, the degree of high definition is also advancing in recording apparatuses, such as printers for recording digital images. Among the aforementioned recording apparatuses, ink-jet recording apparatuses, which utilize an ink-jet recording head, are rapidly becoming popular. As a result, it is desirable to be able to manufacture and market ink-jet recording apparatuses capable of recording high-definition images at reduced costs.

Further, in recent years, the quality of images produced by an ink-jet printer has almost reached the quality level of an ordinary (silver halide) photograph. Accordingly, demand for a value-added multi-function printer with additional functions as well as a printing function is increasing. The increase in such demand largely results from reduced costs of multi-function printers.

Techniques for controlling recording operation in accordance with recording data is conventionally known in printers. For example, techniques for reducing a necessary capacity of a power supply portion, or reducing the cost of a power supply unit (a power supply circuit) are known. According to the aforementioned techniques, a record duty is detected, the detected record duty is compared with a predetermined duty set value, and recording operation (e.g., a degree of thin-out of pixels) is changed based on the comparison result (see Japanese Patent Laid-Open Nos. 8(1996)-252938, and 5(1993)-169681). The record duty is also called a record duty ratio or a recording density. It can be obtained from a ratio between the number of pixels that require driving of a recording head, and the number of pixels that do not require such driving, or the like.

Principal functions of the aforementioned multi-function printer are a printer function, a scanner function, and a copying function. Additionally, a communication function such as a facsimile function may also be a function of a multi-function printer. Most of office work can be handled by a single multi-function printer. As illustrated in FIG. 2, such a multi-function printer 200 is often composed of a printer portion 202, and a scanner portion 201 on which the printer portion 202 is disposed.

Conventionally, a multi-function printer of the above kind is designed mostly for use in an office, and the cost is relatively high. Accordingly, limitations to the manufacturing costs of a power supply unit are relatively generous, and most such printers use a power supply portion capable of supplying power even when image reading and printing operations are simultaneously carried out. Therefore, such a printer does not utilize a special control, such as a control wherein printing modes (recording modes) are exchanged between the image reading time and the non-reading time for the purpose of preventing overload on the power supply portion.

In recent years, however, there has been a trend to manufacture and market multi-function printers designed for use in home. In an attempt to reduce the cost of multi-function printers designed for home use, it would be beneficial to achieve a simultaneous operation of plural functions while reducing the cost of a power supply unit.

### SUMMARY OF THE INVENTION

An aspect of the present invention is that it provides an image processing apparatus that includes an image reader (an image reading portion) and an image recorder (an image recording portion), both of which are supplied power from a common source, which is capable of solving the aforementioned power supply cost reduction issues. The image processing apparatus is adapted to control image reading operation and image recording operation in a well-balanced manner, thereby, reducing power consumption without degrading recording quality. Thus, the capacity of the power supply portion needed to operate the image processing apparatus can be decreased, and the cost, size and weight of the image processing apparatus can be reduced.

According to an embodiment of the present invention, an image processing apparatus is provided which includes an image reading portion; an image recording portion; a power supply portion configured to supply power to the image reading portion and the image recording portion in common; a detecting portion configured to detect a recording density of image data to be recorded by the image recording portion; and a controller configured to compare a detection result of the recording density obtained by the detecting portion with a predetermined threshold, and control a recording operation by the image recording portion based on the comparison. When the detection result of the recording density is equal to or larger than the predetermined threshold, the controller causes the image recording portion to execute a processing of reducing recording power consumed by the image recording portion. Further, the predetermined threshold includes at least a first value and a second value smaller than the first value, and when no image reading is executed by the image reading portion during an image recording operation executed by the image recording portion, the controller compares the detection result with the first value. Also, wherein when image reading is concurrently executed by the image reading portion during the image recording operation executed by the image recording portion, the controller compares the detection result with the second value.

According to another aspect of the present invention, there is provided an image processing apparatus which includes an image reading portion and an image recording portion, in which a detection result of a recording density of image data to be recorded is compared with a predetermined threshold, and process to reduce recording consumption power consumed by the image recording portion is executed when the detection result of the recording density is equal to or larger than the threshold. And, in a case where image reading is executed by the image reading portion during an image recording operation executed by the image recording portion, the threshold is changed from a first value to a second value smaller than the first value. And in another case, the first value is used when no image reading is executed by the image reading portion during the image recording operation executed by the image recording portion. Thereby, the image processing apparatus, is thus, constructed in a manner which reduces the consumption of power during recording.

Other features and aspects of the present invention will become apparent from the following description taken in conjunction with the accompanying drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram illustrating an embodiment of an exemplary image processing apparatus (such as a multi-function printer (MFP)), according to an exemplary embodiment of the present invention.

FIG. 2 is a perspective view illustrating a general external view of an image processing apparatus (such as a multi-function printer (MFP)).

FIGS. 3A to 3C are views showing exemplary detection units of a record duty, respectively.

FIGS. 4A to 4C are views showing an exemplary comparison processing of the record duty, according to an aspect of present invention.

FIG. 5 is a flow chart showing an exemplary flow of a recording control, according to an aspect of the present invention.

### DETAILED DESCRIPTION OF THE PREFERRED EMBODIMENTS

A description will hereinafter be given for embodiments of an exemplary multi-function printer (MFP) which includes an image reader (an image reading portion) and an image recorder (an image recording portion), according to an aspect of the present invention, with reference to the Figures.

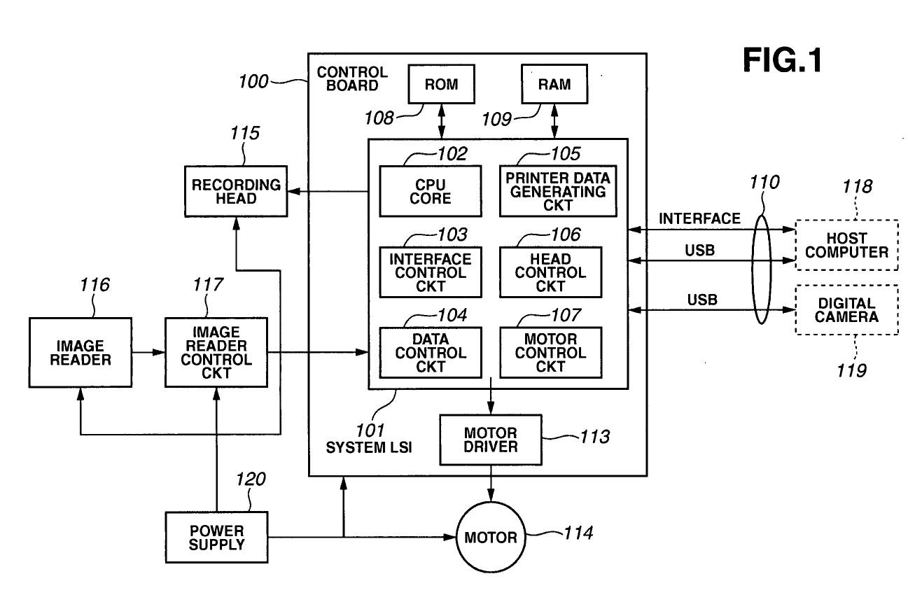

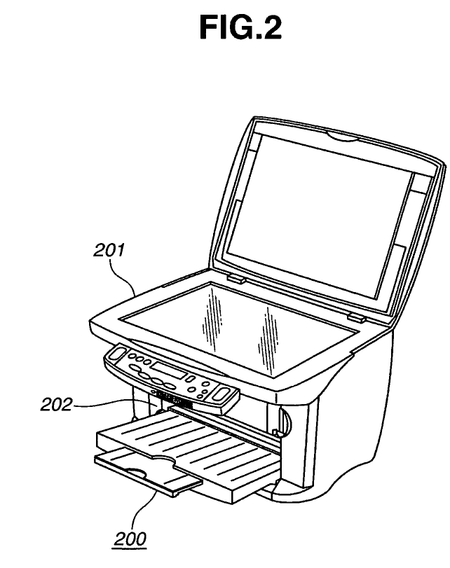

FIG. 1 illustrates the architecture of an exemplary embodiment of a multi-function printer 200 (see also FIG. 2), according to an aspect of the present invention. In FIG. 1, reference numeral 100 designates a control board equipped with electrical elements for controlling a recording apparatus. Reference numeral 101 designates a SYSTEM LSI (a large scale integration).

The SYSTEM LSI 101 includes a CPU CORE 102, an interface control circuit 103 for transmitting and receiving data to and from a host computer 118 and a digital camera 119 through an interface 110, a data control circuit 104 for performing reading control and/or writing control of data on a receive buffer and print buffer provided in a RAM 109, a print data generating circuit 105 for performing generation of print data, a head control circuit 106 for performing data transfer of the generated print data to a recording head 115 and control of ink ejection of the recording head, a motor control circuit 107 for controlling drives of a carriage motor for scanning a carriage with the recording head 115 mounted thereon, a conveyance motor for feeding and discharging a recording medium, and a maintenance motor for performing cleaning and the like of the conveyance motor and the recording head 115, and a ROM 108 for storing a program for controlling the printer.

A control procedure for carrying out an aspect of the present embodiment (described later) is stored, for example, in the ROM 108 as a program of the CPU CORE 102, and the program is supplied therefrom.

Further, the MFP 200 of the exemplary embodiment includes an image sensor for reading an image, an image reader (an image reading mechanism) 116 comprised of a scan motor for performing a relative movement between an original and the image sensor, a driving system for the scan motor, or the like, and an image reader control circuit 117 for performing control of image processing by the image reader 116, control of the scan motor, etc.

In the image recording operation, upon receiving image data from the host computer 118 and the digital camera 119 through the interface 110 (such as, for example, a parallel interface (IEEE1284) port, or a USB), received data is temporarily stored in the receive buffer allotted to the RAM 109 by the interface control circuit 103 and the data control circuit 104 in the SYSTEM LSI 101. Command analysis of the received data stored in the receive buffer is executed. Print data processing of actual image data is performed by the print data generating circuit 105, and the actual image data is then stored in the print buffer allotted to the RAM 109. Upon storage of a necessary amount of data in the print buffer, the print data is read from the print buffer in a predetermined timing by the head control circuit 106. The print data is then transferred to the recording head 115.

Further, during a moving process of the recording head 115 in a main-scanning direction, driving pulses are supplied to the recording head 115 under a control by the head control circuit 106. The print operation of the recording head 115 is thereby performed, and an image is formed on a recording medium (for example, a recording sheet). The scan of the recording head 115 and the conveyance of the recording medium are carried out when the carriage motor, the conveyance motor, and the sheet feed and discharge motor 114 are driven by the motor control circuit 107 through a motor driver 113.

Power is supplied to the respective portions of the system from a power supply portion 120. When the apparatus is designed for use in a home, for example, reduction in size, weight or cost is an important consideration with respect to the power supply portion 120. In such a case, the ability of a power supply portion for a home application may be somewhat restricted, as compared with an apparatus for use in an office and the like.

One aspect of the present embodiment is to control operations of image reading and image recording in a well-balanced manner even in a system in which the ability of the power supply portion 120 is limited as described above. By implementing such a power management scheme, power consumption may be reduced without lowering the quality of recording. And further yet, the apparatus may even be operated within the limited power supply ability of the power supply portion 120.

In another aspect of the present embodiment, the recording operation on a side of a recording unit, including the recording head 115, is controlled pursuant to whether the image reader 116 performs the image reading operation or not. Here, when the image reader 116 is under a condition of the image reading operation, the recording operation is controlled such that the load on the power supply portion 120 becomes small. Upon detection of the stop of the image reading operation, the recording operation is controlled such that the power supply load is returned to that prior to the reduced power supply load.

More specifically, a print buffer region corresponding to the recording region of a single scan is divided into a plurality of blocks, and the record duty in each block is detected prior to start of the recording scan. Additionally, for a unit of the block, a set value (also simply referred to as a threshold) of the record duty drivable at the time of the recording scan, is beforehand, set according to the power supply ability of the power supply portion 120. Next, the record duty set value and the record duty detected in each block are compared with each other.

When the record duty detected in the block exceeds the record duty set value (the threshold), power to be consumed in the recording operation is reduced, saved and/or inhibited from being used. Further, when the image reading operation is detected, the apparatus is controlled so that power saved by reducing the record duty set value (the threshold) can be supplied to the image reading portion.

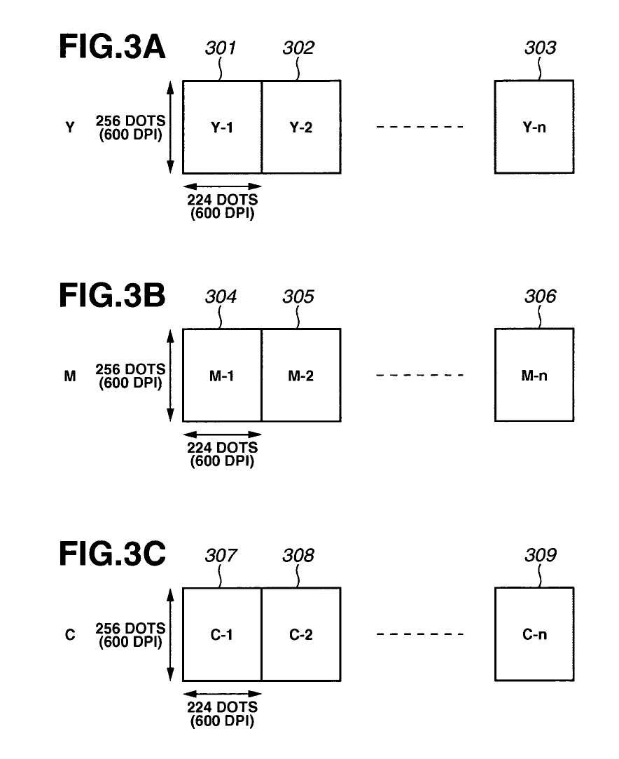

A description will now be given for an exemplary method of detecting and controlling the record duty, with reference to FIGS. 3A to 3C. Here, it is assumed, for sake of example, that color printing using Y (yellow), M (magenta), C (cyan) of inks provided in the recording apparatus is performed, resolution for each color of the above recording head 115 is 600 DPI, and the recording head 115 includes 256 nozzles. However, it is acknowledged that the present invention may be utilized in various different embodiments for MFP's which utilize other configurations of recording heads having varying DPI and nozzle specifications.

FIGS. 3A to 3C show methods in which respective sets of 256 nozzles of Y (yellow), M (magenta), C (cyan) in the recording head 115 perform the recording scan for one line, respectively.

In this embodiment, for example, a portion of the width of nozzles of Y multiplied by one scan is divided into a plurality of blocks Y-1 to Y-n (301 to 303), and the record duty is detected for each block unit of these blocks Y-1 to Y-n. Further, print data for actually ejecting ink is assumed to be “1” of binary data. Accordingly, the number of pixels whose print data is “1” is counted in this case.

Also, in this embodiment, the above portion is divided into the blocks with 256 dots×224 dots as represented by reference numerals 301 to 303, and the record duty is detected. The block is not necessarily a region with 256 dots×224 dots. The block can be any unit region that is pre-determined such that a change in the record duty can appear as the load on the power supply portion 120. Moreover, the size of a block to be counted can be further decreased. In this case, count values obtained from the decreased blocks having a region smaller than the region with 256 dots×224 dots are summed up, and the record duty is detected.

Similarly, recording regions for nozzles of M and C are divided into blocks as represented by reference numerals 304 to 306 (see FIG. 3B), and 307 to 309 (see FIG. 3C), respectively. For each color, the record duty is detected. Such detection of record duties is executed prior to start of the recording scan. In another alternative embodiment, the process can be simplified by only performing detection of the record duty for one or two of Y, M and C colors.

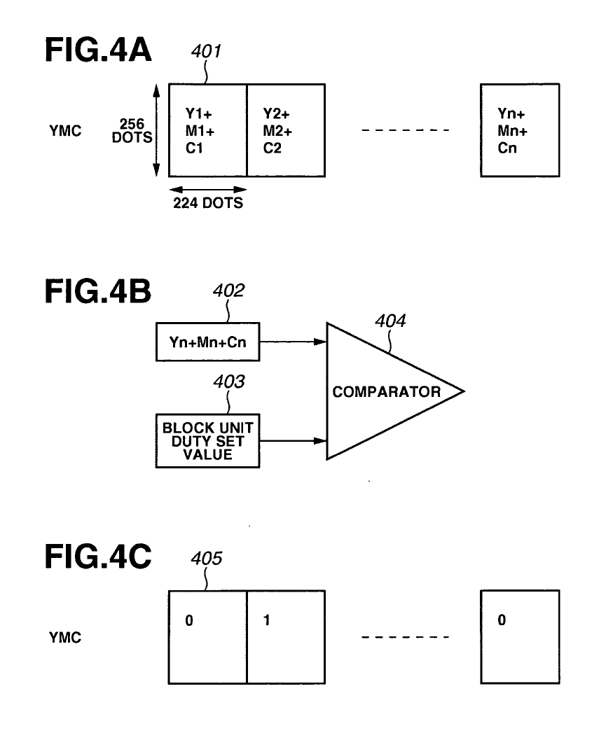

A description will now be given for an exemplary process of setting the record duty based on a comparison between the detected value of the record duty (the record duty detected value) and the record duty set value, with reference to FIGS. 4A to 4C.

In connection with each block 40l with 256 dots×224 dots, record duties (count values of ejection dots) for Y, M and C are summed up to obtain a record duty detected value (Yn+Mn+Cn) 402. The record duty detected value (Yn+Mn+Cn) 402 is compared with a block unit duty set value 403 by a comparator 404. The comparator 404 may be composed of a hardware circuit, or implemented by software for the CPU CORE 102, for instance.

The block unit duty set value 403 may be determined from the supply ability (the supply specification) of the power supply portion 120, consumption power of the recording head 115 capable of being mounted, consumption power of the motor, and the like. In the aforementioned embodiment, at least two set values are prepared. One is a first value to be used when the image reader 116 does not perform the image reading operation, and the other is a second value to be used when the image reader 116 performs the image reading operation. The second value of the block unit duty set value 403 is normally set smaller than the first value.

The block unit duty set values 403 can be fixed pre-determined as set values stored in the ROM or the like. These values, however, can also be dynamically set according to automatically-detected characteristics of the recording head (more specifically the specification of its power consumption amount, etc.), or the like at the time when the recording apparatus is turned on, or the recording head is mounted, for example.

For each block, when the record duty detected value (Yn+Mn+Cn) 402 is found to be equal to or larger than the block unit duty set value 403 after the comparison therebetween, a control flag is set as “1” (e.g., 405 shown in FIG. 4C). When the record duty detected value (Yn+Mn+Cn) 402 is smaller than the block unit duty set value 403, the control flag is set as “0” (e.g., 405 shown in FIG. 4C).

In one-scan printing illustrated in FIGS. 3A to 3C, and FIGS. 4A to 4C, if the load exceeds the supply amount of the power supply portion 120 even in a portion of the on-scan region, voltages supplied to the recording head 115 and the motor are lowered. As a result, there is a possibility of deterioration of a recording image and erroneous operation.

Accordingly, when even one of the values flagged by the control flag is “1” (as shown in FIG. 4C) in the one-scan block, the recording control is changed to lighten the load on the power supply portion 120. Processing of decreasing the recording consumption power, such as thin-out processing of recording data, processing of increasing the thin-out rate of recording data, or processing of increasing the number of recording scans for the same region on the recording medium, is then carried out.

In this embodiment, when the image reader 116 performs the image recording operation, the block unit duty set value 403 is changed such that the processing of decreasing the recording consumption power can be started with a smaller record duty.

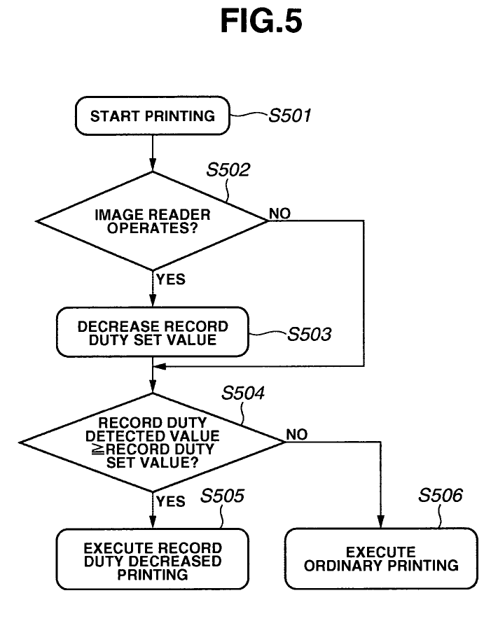

FIG. 5 illustrates an exemplified flow chart of the above-discussed control. The control shown in FIG. 5 may be implemented as software for the CPU CORE 102, which is stored in the ROM 108.

In the flow chart of FIG. 5, printing data is prepared (e.g., image data is input from the host computer 118, or the digital camera 119), and a printing operation is started in the printer (step S501). Thereupon, it is next determined/detected whether or not the image reader 116 operates (step S502).

When the image reader 116 is in the image recording operation, the block unit duty set value 403 is changed from the first value (which is used when no image reading is executed) to the second value (which is used when image reading is executed) (step S503). As described above, the second value is smaller than the first value. On the other hand, when the image reader 116 is not in the image recording operation, step S503 is skipped and step S504 is carried out.

In step S504, the record duty detected value 402 for each block unit is compared with the block unit record duty set value 403. Here, determination is executed, based on the control flags (e.g., 405 shown in FIG. 4C), whether there is in one scan even a block where the record duty detected value for the block unit is equal to or larger than the block unit record duty set value 403, or not.

When there is in one scan even a block where the record duty detected value for the block unit is equal to or larger than the block unit record duty set value 403, a record duty decreased printing (recording) is executed and the load on the power supply portion is decreased (step S505). When there is in one scan no block where the record duty detected value for the block unit is equal to or larger than the block unit record duty set value 403, a printing mode remains unchanged and an ordinary printing is executed (step S506).

In step S505, recording control executed when the record duty detected value for the block unit is above the block unit record duty set value 403 can be the same between the case where the block unit record duty set value 403 is the first value (which is used when no image reading is executed) and the case where the block unit record duty set value 403 is the second value (which is used when image reading is executed). However, the recording control in the case of the first value can be different from the recording control in the case of the second value.

A description will now be given for an example wherein the thin-out rate of recording data is changed. Here, the thin-out rate of recording data is set to 25% in step S505 when the record duty detected value is above the first value of the block unit record duty set value 403 in step S504, and the thin-out rate of recording data is increased up to 40% in step S505 when the record duty detected value is above the second value of the block unit record duty set value 403 in step S504.

A description will be given for another example wherein the number of main-scanning recording operations for the same recording region is controlled. Here, main-scanning recording operations are carried out twice for the same recording region in a recording medium when the record duty detected value is above the first value of the block unit record duty set value 403 in step S504, and main-scanning recording operations are carried out three times for the same recording region in a recording medium when the record duty detected value is above the second value of the block unit record duty set value 403 in step S504.

The control shown in FIG. 5 is executed at the time when the recording operation is started (per a unit of one page), for example. In the event that non-operation of the image reader 116 is detected in a concurrent timing with the time when the recording operation is started (per a unit of one page), the block unit record duty set value 403 is set to the first value that is used when no image reading is executed.

As discussed above, in this embodiment, the recording region for one scan is divided into plural blocks, and the record duty is detected for each block. The detected record duty is compared with the predetermined block unit record duty set value (the first value or the second value). When there is in one scan line even a block where the record duty detected value exceeds the block unit record duty set value, the apparatus is controlled such that a predetermined operation of reducing recording consumption power is operated.

When image reading is executed by the image reader, the block unit record duty set value is changed from the first value to the second value smaller than the first value that is used when no image reading is executed by the image reader. This smaller block unit record duty set value is thus used as the threshold, and the apparatus is controlled so as to start up the control with the reduced recording power consumption. Due to the reduction in the recording power consumption, it is possible to decrease the capacity of a power supply portion needed to operate the entire apparatus, even when the image reader operates. Accordingly, the size and weight of the power supply portion can be reduced, and the cost, size and weight of the entire apparatus can be reduced.

Therefore, according to an aspect of the present embodiment, the reduction rate of the power consumption in the control of the reduced recording power consumption started up with the second value of the block unit record duty set value is set larger than that in the control of the reduced recording power consumption started up with the first value of the block unit record duty set value. Furthermore, a larger reduction efficiency of the recording power consumption can be achieved by the present embodiment. Further, problems, such as occurrence of erroneous operation of the image reading system or the image recording system during the operation of the apparatus, can be assuredly prevented.

According to another aspect of the present embodiment, the image reading operation and the recording operation are controlled in a well-balanced manner irrespective of operation and non-operation of the image reader 116. Hence, the consumption power can be reduced without lowering the recording quality, the capacity of a power supply portion needed to operate the apparatus can be decreased, and the cost, size and weight of the image processing apparatus can be reduced.

Furthermore, to further assure the operation of the recording apparatus, it is possible to detect if the image reader 116 operates or not per a unit of one main-scanning recording operation. Thus, even in a case where the image reader 116 starts to operate during the recording operation of recording data with a large load on the power supply portion, the power consumption can be further reduced.

With respect to the above discussion, the change in the thin-out rate of recording data and the change in the number of recording scans for the same region are exemplified as the control for reducing the load on the power supply portion. It is also possible to adopt a method of controlling the number of concurrently-driven motors, a method of changing the printing mode to another printing mode with further reduced power consumption, or the like.

The apparatus and method of the present invention can be applied to any apparatus other than the above-discussed multi-function printer, so long as the apparatus is an image processing apparatus that includes an image reader and an image recorder both operable by power supply from the same power supply portion. Further, a control software program of the present invention can be stored in a ROM from the beginning of shipment of an image processing apparatus. Alternately, a control software program of the present invention can be supplied to a host apparatus from a variety of external memory media (a CDROM, a flexible disk, and the like), or a control software program of the present invention can be supplied to a host apparatus from a desired server via a network.

As many apparently widely different embodiments of the present invention can be made without departing from the spirit and scope thereof, it is to be understood that the invention is not limited to the specific embodiments thereof except as defined in the claims.

This application claims priority to Japanese Patent Application No. 2004-295527, filed Oct. 8, 2004, the contents of which are hereby incorporated by reference.

What is claimed is:

1. An image processing apparatus comprising:
an image reading portion;
an image recording portion;
a power supply portion configured to supply power to the image reading portion and the image recording portion in common;
a detecting portion configured to detect a recording density of image data to be recorded by the image recording portion; and
a controller configured to compare a detection result of the recording density obtained by the detecting portion with a predetermined threshold, and control a recording,
wherein when the detection result of the recording density is equal to or larger than the predetermined threshold, the controller causes the image recording portion to execute a processing of reducing recording power consumed by the image recording portion,
wherein the predetermined threshold includes at least a first value and a second value smaller than the first value, and when no image reading is executed by the image reading portion during an image recording operation executed by the image recording portion, the controller compares the detection result with the first value, and
wherein when image reading is concurrently executed by the image reading portion during the image recording operation executed by the image recording portion, the controller compares the detection result with the second value.

2. The image processing apparatus according to claim 1, wherein the controller performs control in such a manner that the recording power consumption in the processing of reducing the recording power consumption, which is started up when using the second value as the threshold, is smaller than the recording power consumption in the processing of reducing the recording power consumption which is started up when using the first value as the threshold.

3. The image processing apparatus according to claim 1, wherein the controller performs control in such a manner that the detection of the recording density of the image data and the comparison of the recording density of the image data with the threshold are carried out per a unit of one block of a plurality of blocks obtained by dividing a recording region of one recording scan into a plurality of portions, respectively, and the processing of reducing the recording power consumption is executed when even a block, where the detection result of the recording density is equal to or larger than the threshold, is detected in one recording scan.

4. The image processing apparatus according to claim 1, wherein the controller performs control in such a manner that the processing of reducing the recording consumption power is executed by changing a thin-out rate of recording data.

5. The image processing apparatus according to claim 1, wherein the controller performs control in such a manner that the processing of reducing the recording power consumption is executed by changing the number of recording scans for the same region on a recording medium.

6. The image processing apparatus according to claim 1, wherein the controller performs control in such a manner that the processing of reducing the recording power consumption is executed by reducing a number of concurrently-driven motors provided in the image recording portion.

7. A control method for controlling an image processing apparatus including an image reading portion, an image recording portion, and a power supply portion for supplying power to the image reading portion and the image recording portion in common, the method comprising the steps of:
detecting a recording density of image data to be recorded by the image recording portion; and
executing a processing of reducing recording power consumed by the image recording portion when a detection result of the recording density is compared with a predetermined threshold and the detection result of the recording density is equal to or larger than the predetermined threshold;
wherein the predetermined threshold includes at least a first value and a second value smaller than the first value, and when no image reading is executed by the image reading portion during an image recording operation executed by the image recording portion, the detection result of the recording density is compared with the first value, and
wherein when image reading is concurrently executed by the image reading portion during the image recording operation executed by the image recording portion, the detection result of the recording density is compared with the second value.

8. The control method according to claim 7, wherein the executing step includes a step of performing control in such a manner that the recording power consumption in the processing of reducing the recording power consumption, which is started up when the second value is used as the threshold, is smaller than the recording power consumption in the processing of reducing the recording power consumption which is started up when the first value is used as the threshold.

9. The control method according to claim 7, wherein the detecting step includes performing the detection of the recording density of the image data and the comparison of the recording density of the image data with the threshold per a unit of one block of a plurality of blocks obtained by dividing a recording region of a one recording scan into a plurality of portions, respectively, and the executing step includes performing the processing of reducing the recording power consumption when even a block, where the detection result of the recording density is equal to or larger than the threshold, is detected in one recording scan

10. The control method according to claim 7, wherein the executing step includes performing the processing of reducing the recording power consumption by changing a thin-out rate of recording data.

11. The control method according to claim 7, wherein the executing step includes a performing the processing of reducing the recording power consumption by changing the number of recording scans for the same region on a recording medium.

12. The control method according to claim 7, wherein the executing step includes performing the processing of reducing the recording power consumption by reducing a number of concurrently-driven motors provided in the image recording portion.

13. The control method according to claim 7, wherein the executing step includes performing the processing of reducing the recording power consumption by changing a printing mode to a predetermined printing mode with further reduced power consumption.

14. A computer readable medium containing computer-executable instructions for controlling an image processing apparatus including an image reading portion, an image recording portion, and a power supply portion for supplying power to the image reading portion and the image recording portion in common, the computer readable medium comprising:
computer-executable instructions for detecting a recording density of image data to be recorded by the image recording portion; and
computer-executable instructions for executing a processing of reducing recording power consumed by the image recording portion when a detection result of the recording density is compared with a predetermined threshold and the detection result of the recording density is equal to or larger than the predetermined threshold,
wherein the predetermined threshold includes at least a first value and a second value smaller than the first value, and when no image reading is executed by the image reading portion during an image recording operation executed by the image recording portion, the detection result of the recording density is compared with the first value, and
wherein when image reading is concurrently executed by the image reading portion during the image recording operation executed by the image recording portion, the detection result of the recording density is compared with the second value.
